(19) United States
(12) Patent Application Publication
(10) Pub. No.: US 2017/0076407 A1
(43) Pub. Date: Mar. 16, 2017

(54) LOCATION-BASED DATA STRUCTURE INFORMATION RETRIEVAL AND MODIFICATION

(71) Applicant: Quasar Blu, LLC, Atlanta, GA (US)

(72) Inventor: Mark Thomas, Atlanta, GA (US)

(21) Appl. No.: 15/263,333

(22) Filed: Sep. 12, 2016

Related U.S. Application Data
(60) Provisional application No. 62/217,798, filed on Sep. 11, 2015.

(51) Int. Cl. G06Q 50/12

(52) U.S. Cl. CPC G06Q 50/12

(57) ABSTRACT

A system and method for allowing a user to retrieve and update information from a data-structure based on the user's location. The system may be configured to enable users to update a data structure to include establishment information for a particular establishment upon confirmation that the user is updating the data structure form a location that matches a location of the establishment. The system may also process a search from a user and provide the user with a listing of dining establishments that are physically near the user. The user may then select one of the dining establishments returned in the search results to view establishment information for the selected dining establishment retrieved from the data structure. The system may also provide the user with other useful information about the particular dining establishment to enable the user to identify which establishment to visit.

### CROSS REFERENCE TO RELATED APPLICATIONS

This application claims the benefit of U.S. Provisional Patent Application No. 62/217,798, filed Sep. 11, 2015, entitled “Dining Establishment Current Information Tracking Systems and Methods,” which is incorporated herein by reference in its entirety.

### BACKGROUND

When selecting a dining establishment, such as a bar or restaurant, users often search for and consider general descriptions and reviews of the bar or restaurant. The general descriptions and reviews may include, for example, listings of particular drinks and food items that are offered at the dining establishment, reviews of the dining establishment's food or drinks, discussions of the quality of service available at the dining establishment, and/or discussions of the dining establishment's decor.

However, when searching for a particular dining establishment, users may be seeking a particular type of social scene. For example, a user who is currently on a date may be seeking a quiet bar where the user can have a drink with their date and talk without excessive background noise. On the other hand, a user who is single and looking to meet other single people, may want to choose an establishment that is currently active and full of young, happy, attractive, single people. Accordingly, there is currently a need for systems and methods for allowing a user to select a dining establishment based on the current (or anticipated future) social scene at the bar.

### SUMMARY OF THE VARIOUS EMBODIMENTS

A non-transitory computer-readable medium, in various embodiments, stores computer-executable instructions for: (1) receiving, from a first user, via a user interface of a first portable computing device associated with the first user, a first request to update a data structure to include first bar activity information for a first bar, the data structure being a data structure that an information tracking server will access to determine current bar activity information for one or more nearby bars to one or more users who initiate a search for one or more nearby bars using their respective portable computing device; (2) at least partially in response to receiving the first request: (a) receiving the first bar activity information for the first bar from the first user via the first portable computing device; (b) determining a current location of the first portable computing device associated with the first user; (c) using the determined current location of the first portable computing device associated with the first user to determine one or more bars that are proximate to the first user; (d) determining whether the one or more bars that are proximate to the first user include the first bar; (e) facilitating a display, to the first user via the user interface of the first portable computing device, of a listing of the one or more bars that are proximate to the first user and prompting the first user to select, via the user interface, the first bar from the listing of the one or more bars that are proximate to the first user; (f) at least partially in response to determining that the one or more bars that are proximate to the first user include the first bar and receiving a selection, by the first user, of the first bar from the listing of the one or more bars that are proximate to the first user: (i) updating the data structure to include the first bar activity information for the first bar; and (ii) associating the first bar activity information for the first bar with the first bar in the data structure; (3) receiving, from a second user, via a user interface of a second portable computing device associated with the second user, a second request to initiate a search for one or more nearby bars; (4) at least partially in response to receiving the second request: (a) determining a current location of the second portable computing device associated with the second user; (b) using the determined current location of the first portable computing device associated with the second user to initiate the search for one or more nearby bars; (c) completing the search, by locating one or more bars that are within a particular distance of the determined current location of the second portable computing device associated with the second user; (d) facilitating a display, to the second user via the user interface of the second portable computing device, of a listing of one or more bars identified in the search; (e) retrieving, from the data structure, the current activity information for the one or more bars identified in the search; and (f) displaying, to the second user via the user interface of the second portable computing device, the current bar activity information for at least one of the one or more bars identified in the search.

A computer-readable medium, according to various embodiments, stores computer-executable instructions for: (1) facilitating a search, by a user, for one or more bars (or any other suitable dining establishment, concert location, etc.); (2) at least partially in response to completing the search, facilitating a display, to the user, of a listing of one or more bars identified in the search; (3) facilitating a selection, by the user, of a particular one of the one or more bar listings, the particular listing corresponding to a particular bar; (4) receiving current bar activity information, regarding the particular bar, for a time period that is substantially contemporaneous with the user's selection of the particular bar listing; and (5) at least partially in response to the user selecting the particular bar listing, facilitating a display of the current bar activity information to the user. The current bar activity may include, for example: (1) the number of customers who are at the bar; (2) one or more bartenders who are currently working at the bar; (3) the genre of music that is currently being played at the bar; (4) a general indication of the current mood at the bar (e.g., “chill”, “party”, etc . . . ); (5) a particular song that is currently being played at the bar; (6) a band that is currently playing at the bar; (7) an indication as to whether one or more televisions are on at the bar; (8) an indication as to which show or shows (e.g., which particular sporting events) are being shown at the bar; (9) an indication as to how many people are currently watching a particular show (e.g., sporting event) at the bar; (10) an indication as to how many fans of a particular sports team are at the bar and/or watching a particular sporting event at the bar; (11) an indication of the current dress code at the bar; (12) an indication of the number of individuals of one or more particular genders at a particular bar (e.g., 10 men, 20 women); (13) a general or specific indication of the age (e.g., average age, age ranges) of customers at the bar; (14) a general or specific subjective rating of the attractiveness (e.g., beauty, sex-appeal, style, etc.) of one or more individuals at the bar (e.g., each of a plurality of individuals who are currently at the bar may submit a “vote”, using an app, as to how good looking the collective crowd at the bar is (e.g., on a scale of 1-10)); (15) a general or specific subjective rating of how well dressed one or more individuals at the bar is (e.g., each of a plurality of individuals who are currently at the bar may submit a “vote”, using an app, as to how well dressed the collective crowd at the bar is (e.g., on a scale of 1-10)); and/or (16) any other particular information. It should be understood that any concepts described herein in regard to a “bar,” may also be applied to other establishments, such as other dining establishments (e.g., restaurants).

A computer system, according to various embodiments, is adapted for facilitating informing a user about the current environment at a particular dining establishment (e.g., a bar or restaurant). In particular embodiments, the system comprises at least one processor and memory and the system is adapted for: (1) facilitating a search by a user for one or more dining establishments; (2) at least partially in response to completing the search, facilitating a display to the user of a listing of one or more dining establishments identified in the search; (3) facilitating a selection by the user of a particular one of the one or more dining establishment listings, the particular listing corresponding to a particular dining establishment; (4) receiving current dining establishment activity information regarding the particular dining establishment for a time period that is substantially contemporaneous with the user's selection of the particular dining establishment listing; and (5) at least partially in response to the user selecting the particular dining establishment listing, facilitating a display of the current dining establishment activity information to the user.

A computer system, according to various embodiments, is adapted for facilitating informing a user about the current environment at a particular dining establishment (e.g., a bar or restaurant). In particular embodiments, the system comprises at least one processor and memory and the system is adapted for: (1) receiving dining establishment information from at least two people within the particular dining establishment about an overall subjective appearance rating of one or more people at the dining establishment; (2) receiving dining establishment information from at least two people within the particular dining establishment about a percentage of a particular sex of the one or more people at the dining establishment; (3) receiving dining establishment information from at least two people within the particular dining establishment about a percentage of a particular age of the one or more people at the dining establishment; and (4) displaying to a user in real-time (e.g., substantially real time) the overall subjective appearance rating, the percentage of the particular sex, and the percentage of the particular age of the one or more people at the dining establishment.

### BRIEF DESCRIPTION OF THE DRAWINGS

Various embodiments of a location-based data structure information retrieval and modification system are described herein. In the course of this description, reference will be made to the accompanying drawings, which are not necessarily drawn to scale and wherein:

FIG. 1 is a block diagram of a location-based data structure information retrieval and modification system in accordance with an embodiment of the present system including a dining establishment information tracking server;

FIG. 2 is a block diagram of the dining establishment information tracking server of FIG. 1;

FIG. 3 illustrates a flowchart that generally illustrates various steps executed by a dining establishment information management module according to a particular embodiment;

FIG. 4 illustrates a flowchart that generally illustrates various steps executed by a search module according to a particular embodiment;

FIG. 5 illustrates a flowchart that generally illustrates various steps executed by a dining establishment information display module according to a particular embodiment; and

FIGS. 6-9 are exemplary screen displays of a system according to various embodiments.

### DETAILED DESCRIPTION OF SOME EMBODIMENTS

Various embodiments will now be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

In various embodiments, a location-based data structure information retrieval and modification system is configured to enable retrieval of establishment information from a data structure based on a location of a user. For example, the system may be configured to facilitate retrieval of establishment information for one or more establishments that are proximate to a user who may, for example, desire to view information about one or more nearby establishments. In still further embodiments, the location-based data structure information retrieval and modification system may limit modification of establishment data for particular establishments by requiring that a user attempting to modify the establishment information (e.g., by adding new establishment information such as current establishment information, by removing establishment information, etc.) be physically present at the particular establishment in order to modify the establishment information associated with the particular establishment in the data structure.

Such a system may, for example, be configured to allow potential customers to assess the current “vibe” at a particular dining establishment that happens to be nearby (e.g., a bar, restaurant, or other dining establishment). The “vibe” information may include the dining establishment's decor, social scene, menu, dress code, etc. The system may be adapted, for example, to: (1) allow a user to search for nearby dining establishments; (2) display a listing of nearby dining establishments along with a series of pictures that may include, for example, a particular drink that is featured at the dining establishment; and (3) display a set of one or more current pictures that depict the current “vibe” at the dining establishment—these pictures may be obtained, for example, from other users of the computer system, or from a social media application, such as Instagram or Facebook. The system may, as mentioned above, limit submission of such media to other users that are actually present at the particular dining establishment in order to provide a more accurate assessment of the “vibe” of the particular establishment.

The system may also display: (1) a list of working service providers and other servers/staff (e.g., bartenders, servers, waitstaff, DJs, chefs, etc.) who are currently working at the dining establishment (and/or a list of service providers and other servers/staff who are employed by the dining establishment and who are not currently working); and/or (2) a list of other users of the system who are currently at the dining establishment, who have plans to go to the dining establishment that day, who are currently traveling to the dining establishment, or who have been at the dining establishment recently. The system may be useful in helping users to identify which establishment to patronize on a particular day by providing the users with information regarding the current atmosphere, staffing, weekly specials, and patronage at the dining establishment.

### Exemplary Technical Platforms

As will be appreciated by one skilled in the relevant field, the present systems and methods may be, for example, embodied as a computer system, a method, or a computer program product. Accordingly, various embodiments may be entirely hardware or a combination of hardware and software. Furthermore, particular embodiments may take the form of a computer program product stored on a computer-readable storage medium having computer-readable instructions (e.g., software) embodied in the storage medium. Various embodiments may also take the form of Internet-implemented computer software. Any suitable computer-readable storage medium may be utilized including, for example, hard disks, thumb drives, compact disks, DVDs, optical storage devices, and/or magnetic storage devices.

Various embodiments are described below with reference to block diagram and flowchart illustrations of methods, apparatuses, (e.g., systems), and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, a special purpose computer, or other programmable data processing apparatus that can direct a computer or other programmable data processing apparatus to function in a particular manner such that the instructions stored in the computer-readable memory produce an article of manufacture that is configured for implementing the functions specified in the flowchart block or blocks.

The computer instructions may execute entirely on the user's computer, partly on the user's computer, as a stand-alone software package, partly on a user's computer and partly on a remote computer, or entirely on the remote computer or server. In the latter scenario, the remote computer may be connected to the user's computer through any suitable type of network, including but not limited to: (1) a local area network (LAN); (2) a wide area network (WAN); and/or (3) a cellular network. It should be understood that a particular computer's connection to the network may be made via an external computer (for example, by connecting to the internet via a “hotspot” provided by a portable wireless device).

The computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer-implemented process (e.g., method) such that the instructions that execute on the computer or other programmable apparatus provide steps for implementing the functions specified in the flowchart block or blocks.

Example System Architecture

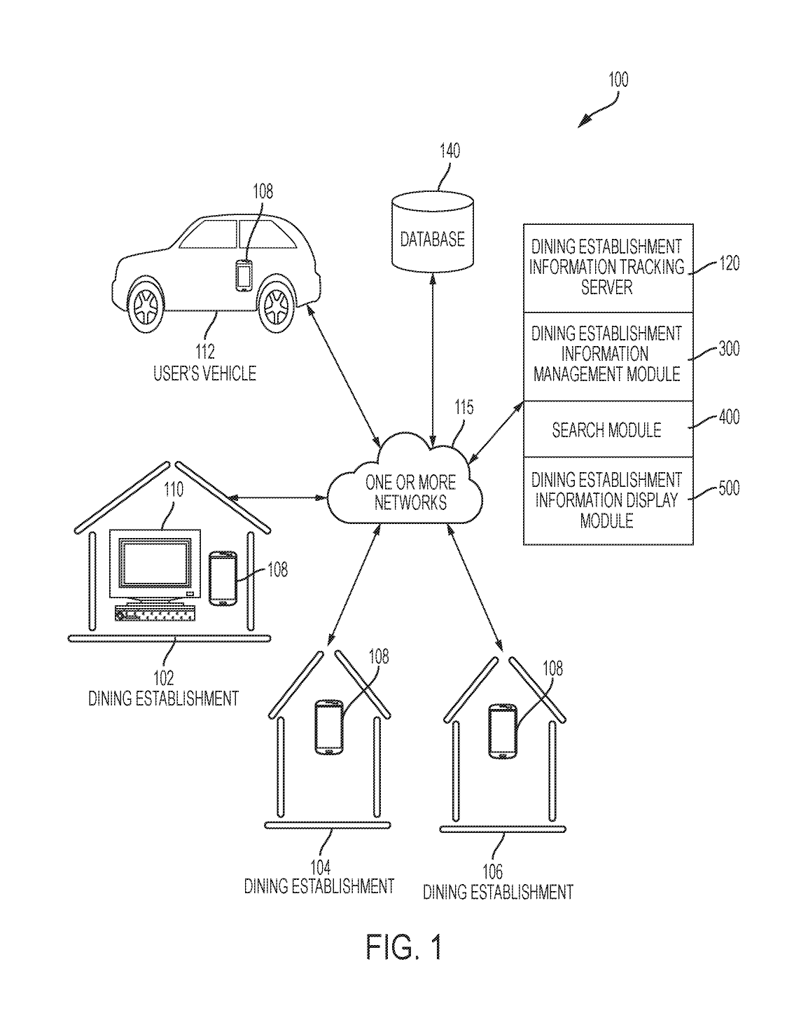

FIG. 1 is a block diagram of a dining establishment information tracking system 100 according to particular embodiments. As may be understood from this figure, the dining establishment information tracking system 100 includes one or more networks 115, a dining establishment information tracking server 120 that may, for example, be adapted to execute a dining establishment information management module 300, a search module 400, and a dining establishment information display module 500. The dining establishment information tracking system 100 may also include a database 140 for consolidating information received from the modules 300, 400, 500. In various embodiments, the dining establishment information tracking system 100 includes one or more dining establishments 102, 104, 106. Each of the dining establishments 102, 104, 106 include one or more remote computing devices 108, 110 (e.g., a smart phone, a tablet computer, a wearable computing device, a laptop computer, a desktop computer, etc.). In some embodiments, the remote computing devices include a smart phone 108 or a desktop computer 110. In various embodiments, the dining establishment information tracking system 100 may also include a user's vehicle 112 that is carrying a remote computing device 108 associated with the user. In particular embodiments, the one or more computer networks 115 facilitate communication between the dining establishment information tracking server 120, the database 140, and the one or more remote computing devices 108, 110.

The one or more networks 115 may include any of a variety of types of wired or wireless computer networks such as the Internet (or other WAN), a private intranet, a mesh network, a public switch telephone network (PSTN), or any other type of network (e.g., a network that uses Bluetooth (standard or low energy Bluetooth), beacon communication technologies (e.g., iBeacon), and/or near field communications to facilitate communication between computing devices). The communication link between the one or more remote computing devices 108, 110 and the dining establishment information tracking server 120 may be, for example, implemented via a Local Area Network (LAN) or via the Internet (or other WAN).

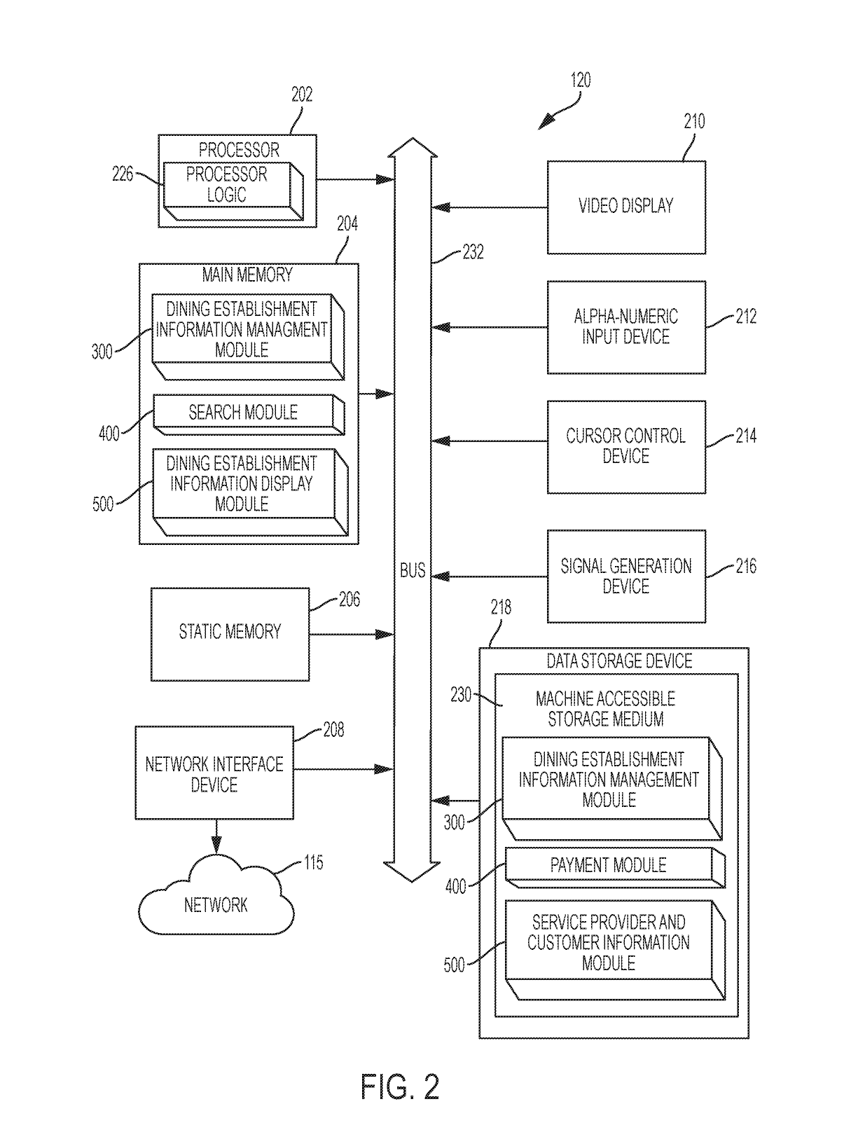

FIG. 2 illustrates an exemplary diagrammatic representation of the architecture for a dining establishment information tracking server 120 that may be used within the dining establishment information tracking system 100. It should be understood that the computer architecture shown in FIG. 2 may also represent the computer architecture for any one of the one or more remote computing devices 108, 110 shown in FIG. 1. In particular embodiments, the dining establishment information tracking server 120 may be suitable for use as a computer within the context of the dining establishment information tracking system 100 that is configured for allowing a user to search for information about a particular dining establishment and displaying the current “vibe” of the dining establishment to the user.

In particular embodiments, the dining establishment information tracking server 120 may be connected (e.g., networked) to other computing devices in a LAN, an intranet, an extranet, and/or the Internet as shown in FIG. 1. As noted above, the dining establishment information tracking server 120 may operate in the capacity of a server or a client computing device in a client-server network environment, or as a peer computing device in a peer-to-peer (or distributed) network environment. The dining establishment information tracking server 120 may be a desktop personal computing device (PC), a tablet PC, a set-top box (STB), a Personal Digital Assistant (PDA), a cellular telephone, a web appliance, a network router, a switch or bridge, or any other computing device capable of executing a set of instructions (sequential or otherwise) that specify actions to be taken by that computing device. Further, while only a single computing device is illustrated, the single term “computing device” (or other such singular terminology referring to a computing device) shall also be interpreted to include any collection of computing devices that individually or jointly execute a set (or multiple sets) of instructions to perform any one or more of the methodologies discussed herein.

As shown in FIG. 2, an exemplary dining establishment information tracking server 120 includes a processor 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other and other system components via a bus 232.

The processor 202 represents one or more general-purpose or specific processing devices such as a microprocessor, a central processing unit (CPU), or the like. More particularly, the processor 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processor 202 may be configured to execute processing logic 226 for performing various operations and steps discussed herein.

The dining establishment information tracking server 120 may further include a network interface device 208. The dining establishment information tracking server 120 may also include a video display unit 210 (e.g., a liquid crystal display (LCD) or a cathode ray tube (CRT)), an alpha-numeric input device 212 (e.g., a keyboard), a cursor control device 214 (e.g., a mouse), and a signal generation device 216 (e.g., a speaker).

The data storage device 218 may include a non-transitory computing device-accessible storage medium 230 (also known as a non-transitory computing device-readable storage medium or a non-transitory computer-readable medium) on which is stored one or more sets of instructions (e.g., the dining establishment information management module 300, the search module 400, and the dining establishment information display module 500) embodying any one or more of the methodologies or functions described herein. The dining establishment information management module 300, the search module 400, and the dining establishment information display module 500 may also reside, completely or at least partially, within the main memory 204 and/or within the processor 202 during execution thereof by the dining establishment information tracking server 120—the main memory 204 and the processing device 202 also constituting computing device-accessible storage media. The dining establishment information management module 300, the search module 400, and the dining establishment information display module 500 may further be transmitted or received over a network 115 via a network interface device 208.

While the computing device-accessible storage medium 230 is shown in an exemplary embodiment to be a single medium, the term “computing device-accessible storage medium”, “computer-readable medium”, and the like should be understood to include a single medium or multiple media (e.g., a centralized or distributed database, and/or associated caches and servers) that store the one or more sets of instructions. The term “computing device-accessible storage medium” should also be understood to include any medium that is capable of storing, encoding, or carrying a set of instructions for execution by the computing device and that causes the computing device to include any one or more of the methodologies of the present invention. The term “computing device-accessible storage medium” should accordingly be understood to include, but not be limited to, solid-state memories, optical and magnetic media, etc.

### Operation of Exemplary System

As noted above, a dining establishment information tracking system 100, according to various embodiments, is adapted to provide users with information about one or more dining establishments. Various aspects of the system's functionality may be executed by certain system modules, including the dining establishment information management module 300, the search module 400, and the dining establishment information display module 500. The dining establishment information management module 300, the search module 400, and the dining establishment information display module 500 are discussed in greater detail below.

Dining Establishment Information Management Module

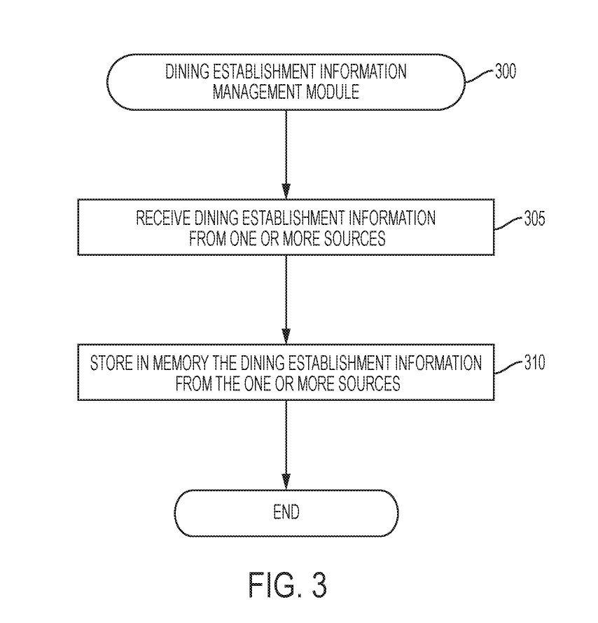

FIG. 3 shows a flow chart of operations performed by an exemplary dining establishment information management module 300, which may, for example, run on the dining establishment information tracking server 120, or any suitable computing device (such as a suitable mobile computing device). In particular embodiments, the dining establishment information management module 300 facilitates receiving information from various sources regarding various dining establishments.

The system begins at Step 305 by receiving dining establishment information from one or more sources. In various embodiments, the system may receive the dining establishment information from a web crawler gathering information from the Internet. In particular embodiments, the system may receive the dining establishment information from a user entering information into a dining establishment information application. In various embodiments, the system may receive the dining establishment information from any suitable social network (e.g., FACEBOOK®, INSTAGRAM®, TWITTER®, LINKEDIN®, TUBMLR®, etc.). In particular embodiments, the system may receive the dining establishment information from any suitable dining-establishment-related network (e.g., OPENTABLE®, MATCHBOOK®, URBANSPOON®, YELP®, etc.). In some embodiments, the system may receive the dining establishment information periodically throughout the day. In various embodiments, the system may receive the dining establishment information after receiving a query for dining establishment information from a particular user.

In particular embodiments, the dining establishment information may relate to any suitable type of dining establishment (e.g., a bar, restaurant, coffee shop, etc.). In various embodiments, the dining establishment information may include general dining establishment information such as one or more of the following: (1) the dining establishment's drink menu; (2) the dining establishment's food menu; (3) the dining establishment's address; (4) a map to the dining establishment; (5) one or more images (e.g., photos, videos, etc.) of the exterior and/or interior of the dining establishment; (6) the dining establishment's dress code; (7) the dining establishment's hours;(8) one or more ratings of the food of the dining establishment; (9) one or more ratings of the service of the dining establishment; (10) one or more reviews of the dining establishment; (11) one or more indications of the typical ambiance and/or decor of the restaurant.

In some embodiments, the dining establishment information may also include time-specific information for the dining establishment such as: (1) one or more bartenders and/or one or more servers (or any other service provider, for example, a chef, DJ, waitstaff, etc.) who are scheduled to work at the dining establishment at a particular time; (2) one or more drink and/or food specials that are scheduled to be offered at the dining establishment a particular time; (3) one or more planned special hours of the dining establishment for a particular holiday; (4) one or more planned activity or entertainment schedules for the dining establishment (e.g., trivia night, live performance schedules, etc.). In particular embodiments, the time-specific dining establishment information may include one or more pieces of media (e.g., one or more videos and/or one or more photographs) that may be used to communicate time-specific information to the user. For example, the time-specific dining establishment information may include a photograph of a particular bartender scheduled to work at a particular time on a particular evening and/or a video of the particular bartender making a drink from the drink specials for that particular time on the particular evening.

In various embodiments, the dining establishment information may also include current dining establishment information (e.g., information regarding the state of the dining establishment at about the current time). The current dining establishment activity may include, for example in the context of a bar: (1) the number of customers who are at the bar; (2) one or more bartenders who are currently working at the bar; (3) the genre of music that is currently being played at the bar; (4) a general indication of the current mood at the bar (e.g., “chill”, “party”, etc . . . ); (5) a particular song that is currently being played at the bar; (6) a band that is currently playing at the bar; (7) an indication as to whether one or more televisions are on at the bar; (8) an indication as to which show or shows (e.g., which particular sporting events) are being shown at the bar; (9) an indication as to how many people are currently watching a particular show (e.g., sporting event) at the bar; (10) an indication as to how many fans of a particular sports team are at the bar and/or watching a particular sporting event at the bar; (11) an indication of the current dress code at the bar; (12) an indication of the number of customers of one or more particular genders at a particular bar (e.g., 10 men, 20 women); (13) a general or specific indication of the age (e.g., average age, age ranges) of customers at the bar; (14) a general or specific subjective rating of the attractiveness (e.g., beauty, sex-appeal, style, etc.) of one or more individuals at the bar (e.g., each of a plurality of individuals who are currently at the bar may submit a “vote”, using an app, as to how good looking the collective crowd at the bar is (e.g., on a scale of 1-10)); (15) a general or specific subjective rating of how well dressed one or more individuals at the bar is (e.g., each of a plurality of individuals who are currently at the bar may submit a “vote”, using an app, as to how well dressed the collective crowd at the bar is (e.g., on a scale of 1-10)); (16) a listing of the names of one or more individuals that are currently at the bar; (17) a listing of the names of one or more individuals that are currently on their way to the bar and/or who plan to go the bar on that particular evening; (18) a list of the names of one or more individuals who were at the bar earlier on the current day, but who are no longer at the bar; (19) one or more profile pictures of one or more individuals who are at the bar; (20) one or more pictures and/or videos of the interior and/or exterior of the bar; (21) information regarding the availability of one or more food and/or beverage items at the bar; (22) the current wait time at the bar (e.g., the average wait time for any size party or the average wait time for a party of a particular size); (23) the availability of a particular table at the bar; (24) the wait time for a particular table at the bar; and/or (25) any other particular information. It should be understood that any concepts described herein in regard to a “bar” may also be applied to other establishments, such as other dining establishments (e.g., restaurants).

In particular embodiments, the system may receive current dining establishment information from a remote computing device associated with a particular service provider (e.g., a particular waiter or bartender at the dining establishment), and/or a particular customer of the dining establishment. For example, the system may receive an indication that a particular bartender is currently working in response to the bartender logging into a particular software application on their portable computing device (e.g., smartphone or tablet computer) and using the application to indicate that they are working. As another example, a user may log into a particular application on their portable computing device to provide any suitable current dining establishment information, such as the types of current dining establishment information discussed herein (e.g., current pictures of the dining establishment, a current subjective assessment of the current mood in the dining establishment, a number of customers currently in the dining establishment, a current song that is playing in the dining establishment, etc.). In particular embodiments, the system may receive current dining establishment information by sending out one or more surveys to one or more users of the dining establishment information application. The one or more surveys, for example, may include questions regarding the current mood and/or current customers.

In particular embodiments, the system establishes information regarding the dining establishment as “current” if the information was received from someone that was at the dining establishment less than a predetermined amount of time from the current time (e.g., within a predetermined number of hours, minutes, or seconds, etc. from the current time). For example, the system may be adapted to establish information as current if it was received from someone that was at the dining establishment less than one hour before the current time.

In particular embodiments, the current dining establishment information may be received directly from a remote computing device (e.g., smartphone, tablet, or laptop computer) that is located at the dining establishment. Alternatively, or in addition, the current dining establishment information may be received from one or more social networks (e.g., FACEBOOK®, INSTAGRAM®, etc.), e.g., via a suitable API.

In various embodiments, the system may only establish information as valid dining establishment information (e.g., valid photos or other information) if the information was received from a remote computing device that was at the dining establishment when the information was transmitted from the remote computing device to a computing device associated with the system (e.g., a system server). This determination of the location of the remote computing device may be done in any suitable way; for example, using one or more GPS devices associated with the remote computing device, using one or more triangulation techniques, or by using any other suitable location determination technique.

For example, the system may, in response to receiving a request from a remote computing device (e.g., a customer's smartphone) to update the information for a particular establishment (e.g., update a data store (e.g., database) to include new information), determine a location of the remote computing device. The system may then compare the determined location with a known location of the particular establishment in order to confirm that the information is being provided from the establishment (e.g., or to confirm that the computing device was recently at the establishment). In various embodiments, the system is configured to provide a listing of establishments to a user attempting to submit information that are within a particular range of a determined location of the user. The system may then prompt the user to confirm the location for which they are attempting to provide information.

In the case of user-submitted media (e.g., one or more photographs or videos), the system may confirm that the media was, in fact, captured at the particular establishment based on EXIF data associated with the media. The EXIF data may include, for example, a longitude and latitude at which the media was captured. The system may then compare data determined from the EXIF data with a known location of the particular location.

As a particular example, the system may provide a software application for installation on a mobile computing device of a user (e.g., a customer, employee of an establishment, etc.). In particular embodiments, the application is configured to allow users to capture media (e.g., record video or take one or more pictures) and request to associate the media with a particular establishment that the user is currently patronizing. For example, if a user is at a particular bar or restaurant, the user can take one or more videos or capture one or more photographs at the establishment. The system may enable the user to associate the captured media with the establishment by, for example, providing a listing of one or more establishments that are located near a determined location of the user (e.g., using one or more suitable GPS techniques to determine a current location of the user's smartphone or other computing device and compare that to known locations of various establishments). The system may determine the location of the user at a time the request to submit the information is made or at any other suitable time. The system may then require the user to confirm the establishment at which they are located by providing confirmation via the software application. In this way, the system may limit modifications to a data structure to include additional media (e.g., or other information) to media that was in fact captured at a particular location (e.g., or to information that was ascertained by a user that was actually physically present at the location). The system may further confirm that the media was captured at the location by comparing EXIF data associated with submitted media to a location of the particular location as described above.

At Step 310, the system stores the general, time-specific, and current dining establishment information, which has been received from the one or more sources, in suitable memory, such as in a dining establishment information database. In particular embodiments, the system may store a time indictor (e.g., a time stamp) along with each piece of current dining establishment information and use the time indicator to establish (e.g., using the techniques discussed above) whether the dining establishment information is still current at a particular time. For example, if the system is programmed to establish that only information that was received within the previous 30 minutes from a computing device at the dining establishment is “current” dining establishment information, the system may: (1) iteratively use the time indicator for a particular information to determine whether the time indicator indicates that the particular information was received from the dining establishment within the past 30 minutes; (2) at least partially in response to determining that the particular information was received from the dining establishment within the past 30 minutes, establish the particular information as “current” dining establishment information; and (3) at least partially in response to determining that the particular information was not received from the dining establishment within the past 30 minutes, establish the particular information as not being “current” dining establishment information. In particular embodiments, the system may remove any dining establishment information from display within a particular application in response to determining that the information has moved from current to non-current status. In various embodiments, the system may store the images and/or display the images in chronological order, reverse chronological order, or in a substantially random order.

In various embodiments, by continuously updating the “current” dining establishment information, the system may reduce a retrieval time in response to a request form a user to display current dining establishment information for one or more particular establishments (e.g., because the system has already determined what constitutes current information and updated it accordingly).

In various embodiments, the system may store establishment information that is no long current as past or historic information. The system may then associate this past or historic information with any suitable information or time. The system may, for example, associate the past or historic information in memory with a particular date on which the information was received. The system may associate the data in memory with one or more other suitable pieces of information about a particular establishment that were also current while the past or historic information was still current information (e.g., such as any suitable information described herein).

In particular embodiments, the system may substantially automatically compile and/or edit the photographs and/or videos received from a particular user by combining the photographs and/or videos into a compilation of the person's night. The system may also determine that two users were together on a particular night and substantially automatically compile the photographs and/or videos of the two users and/or ask the two users for permission to compile the photographs and/or videos. Similarly, the system may compile photographs and/or videos from all users who were in a particular location on a particular day.

The system may, for example, generate a media story for a particular establishment. In various embodiments, generating the media story may include aggregating submitted media associated with the particular establishment in any suitable manner. For example, the system may generate a story for a particular establishment that includes only media submitted by users for the particular establishment within a particular time period (e.g., within the last day, since the establishment opened on the particular day on which the media was captured, etc.). The system may aggregate the submitted media in any suitable order such as, for example: (1) chronologically based on receipt of the media; (2) chronologically based on a time the media was captured; (3) or in any other suitable manner.

In various embodiments, in addition to storing submitted media in the suitable database and associating the submitted media with the proper establishment in memory, the system may associate the submitted media with a particular time at which it was captured. For example, the system may store media for a particular establishment associated with a particular day (e.g., day of the week such as Monday, Tuesday, etc.), a particular time of day (e.g., morning, evening, night), or any other suitable time or combination of times (e.g., Thursday evening). For example, the system may store and index media by day of the week and enable a user to view a media story for the particular establishment comprising media from specific past days, times, or time frames. For example, a user considering whether to go to a particular bar on a Friday night may request to view a media story of media associated with the bar from a previous Friday night (e.g., a specific previous Friday or all previous Fridays) in order to get a sense of what the bar is like on Friday nights (e.g., loud/quiet, crowded, busy, type of music played, etc.). Similarly the system may store past information or historical information (e.g., based on specific times) for any other suitable establishment information discussed herein.

Search Module

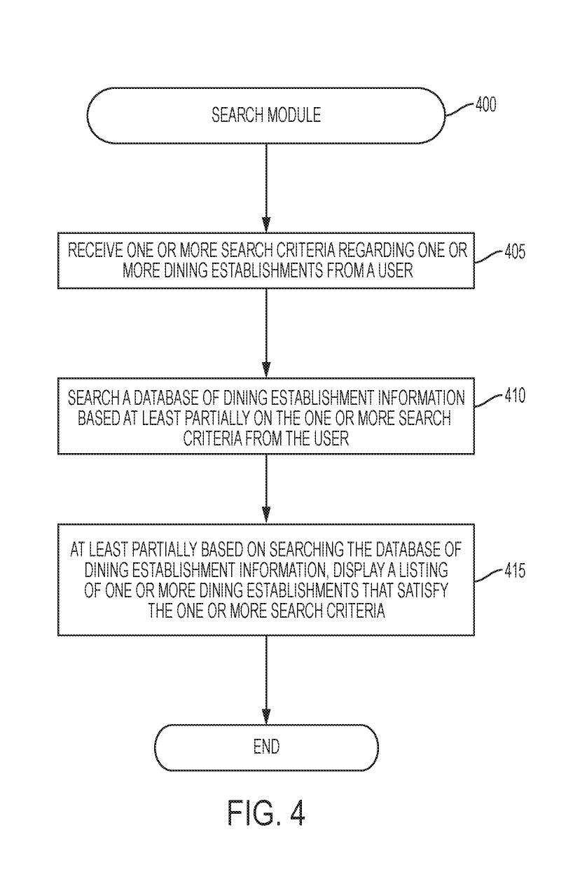

FIG. 4 shows a flow chart of operations performed by an exemplary search module 400, which may, for example, run on the dining establishment information tracking server 120, or any suitable computing device (such as a suitable mobile computing device). In particular embodiments, the search module 400 facilitates a search of various dining establishments by a user. In particular embodiments, the system may be adapted to allow a user to search for dining establishments based on the general, time-specific, and/or current dining establishment information described above. For example, the system may allow a user to search for any nearby dining establishments that: (1) are less than a predetermined percent full (e.g., the dining establishment has a number of current customers that is less than 80% of the dining establishment's capacity); (2) are playing a particular type of music (e.g., jazz, funk, country, swing); (3) have a live band playing; (4) have a current customer population that is over a predetermined percentage of a particular gender (e.g., over 50% female); (5) have a current customer population that has been subjectively judged to be attractive and/or well dressed; (6) have a current noise level that is below, above, or at a particular specified level (which may be a subjective level (e.g., loud) or a specific measured noise level (e.g., a particular decibel level.)); (7) are currently offering a particular drink and/or food special (e.g., happy hour on drinks); (8) are currently showing a particular sporting event; (9) currently have at least a predetermined number of contiguous bar stools open at the dining establishment's bar; (10) currently have seating capacity to accommodate a party of a specified size; (11) currently have at least a predetermined number of the user's friends in attendance; etc . . . . This may, for example, allow a user to locate a dining establishment that has a current environment that is currently desirable to the user.

When executing a particular search, the system begins at Step 405 by receiving one or more search criteria regarding one or more dining establishments from a user. In various embodiments, the system facilitates a search by a user for one or more dining establishments via an application running on a computing device associated with the user (e.g., the user's smartphone or tablet computer). The system may, for example, allow the user to enter one or more search criteria into one or more search fields on a graphical user interface associated with the user.

In particular embodiments, the system may allow the user to search by location, name, decor, mood, specials, etc. For example, a user in the mood for martini specials may enter the search term “martini special” to search for all dining establishments that currently have martini specials. As a further example, the user may search for all dining establishments that have the current mood that has been indicated by other users of the application (e.g., those who are currently at the dining establishment) as “chill.” In some embodiments, the one or more search criteria may include a particular type of dining establishment. For example, the one or more search criteria may include that the user is looking for a bar rather than a restaurant.

In various embodiments, the one or more search criteria may specify that the dining establishment is within a predetermined distance from the user, or at least that that the dining establishment is relatively close to the user. In various embodiments, the predetermined distance may include a predetermined distance form a determined GPS location of a mobile computing device associated with the use.

At Step 410, the system searches a database of dining establishment information based at least partially on the one or more search criteria received from the user. In various embodiments, the system searches the database of stored dining establishment information discussed above in reference to Step 310. In particular embodiments, the system may allow the user to conduct further searches from search results returned for the first search. For example, the user may search for all restaurants within 5 miles of the user and then narrow the results of the search to all Italian restaurants within 5 miles of the user. In various embodiments, the system may search for dining establishments by filtering based on the information obtained by the dining establishment information management module 300. For example, the system may first search via Google Maps, for nearby bars, creating a data structure that includes the listing of bars identified in the search along with specific supplemental information (above) for each bar, and then perform a second search on this data structure. This might allow, for example, a user to search for bars where at least one of user's Facebook friends is currently checked in, or where a favorite band of the user is currently playing and at least 30 customers are currently at the bar, or where the current mood at a particular restaurant is listed as “chill” by at least one user.

Continuing to Step 415, at least partially based on searching the database of dining establishment information, the system displays a listing of one or more dining establishments that satisfy the one or more search criteria. In particular embodiments, the listing of one or more dining establishments may include one or more recommended dining establishments. In some embodiments, the listing of one or more dining establishments may include one or more dining establishments visited by the user in the past. In particular embodiments, the listing of one or more dining establishments may include dining establishments that the user has listed as a “favorite.” In some embodiments, the listing of one or more dining establishments may include dining establishments that the user has listed as wanting to try.

In various embodiments, the dining establishments that satisfy the one or more search criteria may satisfy all of the search criteria. In some embodiments, the dining establishments that satisfy the one or more search criteria may satisfy some of the search criteria. In particular embodiments, the dining establishments that satisfy the one or more search criteria may satisfy a particular percentage of the search criteria (e.g., at least 50%).

In various embodiments, the system may sort the listing of the one or more dining establishments by any of the search criteria received from the user. For example, the system may sort the listing of one or more dining establishments by ratings provided by other users, by cost, by proximity to the user, by mood, by noise level, by decor, by ambiance, by current drink and/or food specials, etc.

Dining Establishment Information Display Module

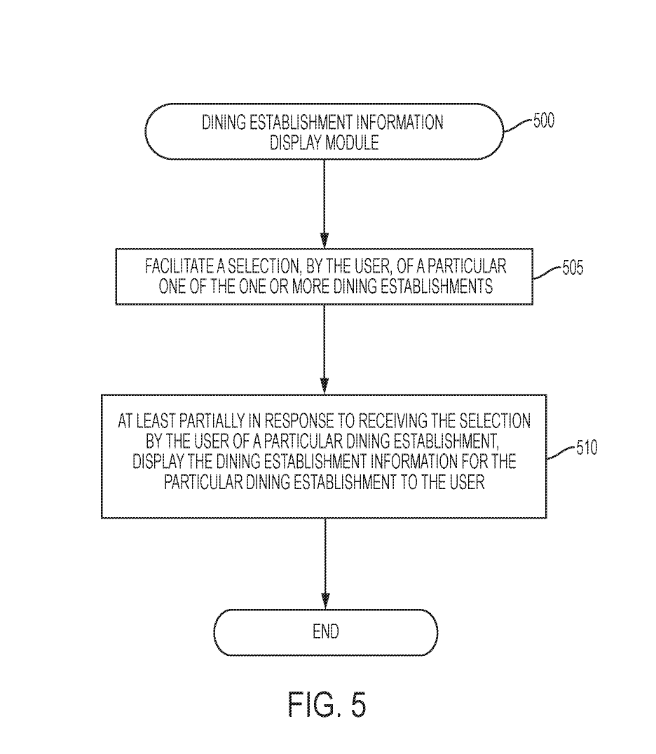

FIG. 5 shows a flow chart of operations performed by an exemplary dining establishment information display module 500, which may, for example, run on the dining establishment information tracking server 120, or any suitable computing device (such as a suitable mobile computing device). In particular embodiments, the dining establishment information display module 500 facilitates displaying the results of a dining establishment search to a user.

The system begins at Step 505 by facilitating a selection, by the user, of a particular one of the one or more dining establishments. In various embodiments, the system may facilitate the selection by the user by pre-selecting a particular dining establishment that matches most closely to the user's one or more search criteria. In some embodiments, the user may select the particular dining establishment by clicking a link associated with the particular dining establishment. In particular embodiments, the system may facilitate the selection by the user on a remote computing device associated with the user. In some embodiments, the system may facilitate the selection by the user by receiving one or more touch events from the user's remote computing device. For instance, if the user swipes right, the touch event may indicate that the user is selecting the particular dining establishment and if the user swipes left, the touch event may indicate that the user is not selecting the particular dining establishment.

At Step 510, at least partially in response to facilitating the selection by the user of a particular dining establishment, the system displays the dining establishment information for the particular dining establishment to the user. In various embodiments, the dining establishment information for the particular dining establishment may comprise any information received and/or stored by the dining establishment information management module 300. For example, the dining establishment information may comprise general, time-specific, and/or current dining establishment information. As a further example, the system may display one or more current photos and/or videos from inside the dining establishment, one or more current videos, listings of one or more currently working bartenders and/or servers, one or more customers who plan to be at the particular dining establishment within the next hour, one or more customers who are currently at the particular dining establishment, one or more customers who have recently left the particular dining establishment, the current mood at the dining establishment (as indicated by one or more individuals who are currently at the dining establishment), the number of customers currently at the particular dining establishment, the ambient noise level at the particular dining establishment (e.g., measured or subjective), etc . . . .

In various embodiments, the system displays past dining establishment information to the user. For example, as discussed above, in various embodiments, the system may store media for a particular establishment associated with a particular day (e.g., day of the week such as Monday, Tuesday, etc.), particular time of day (e.g., morning, evening, night), etc.) for later retrieval by users. For example, the system may store and index media by day of the week and enable a user to view a media story for the particular establishment comprising media from specific past days, times, or time frames. For example, a user considering whether to go to a particular bar on a Friday night may request to view a media story of media associated with the bar from a previous Friday night (e.g., a specific previous Friday or all previous Fridays) in order to get a sense of what the bar is like on Friday nights (e.g., loud/quiet, crowded, busy, type of music played, etc.). The system may then display, to the user, the media story from a previous Friday night (e.g., in addition to other information about the particular bar on Friday nights).

In another example, in some embodiments, if a particular music act or performer is performing at an establishment on a particular night, a user may desire to view a media story for the establishment on a previous night that the performer has performed at the establishment. In such embodiments, the system may store and index media stories for a particular night based on performances or specials occurring at the establishment. For example, the system may enable users to view establishment information for previous nights with one or more factors that are substantially similar to a current (e.g., or future) day or time for which they would like to get a sense of the ‘vibe’ (e.g., one or more previous nights with the same staff working at the establishment, one or more previous nights with similar drink specials or other specials occurring, etc.) In this way, the system may enable users to retrieve one or more media stories containing media captured at a particular establishment under conditions similar to those that the user may expect to find if the user were to elect to patronize the establishment at a particular future time.

In various embodiments, the system may convey the dining establishment information for the particular dining establishment to the user in any suitable way. For example, the system may display the dining establishment information for the particular dining establishment on the display of the user's remote computing device. In some embodiments, the system may emit a sound in connection with displaying the dining establishment information for the particular dining establishment. For example, where the mood of the dining establishment is listed as “chill,” the system may play a smooth jazz song. In various embodiments, the system may color-code the display of the dining establishment information for the particular dining establishment based on the type of information.

Exemplary User Experience

Searching Nearby Dining Establishments

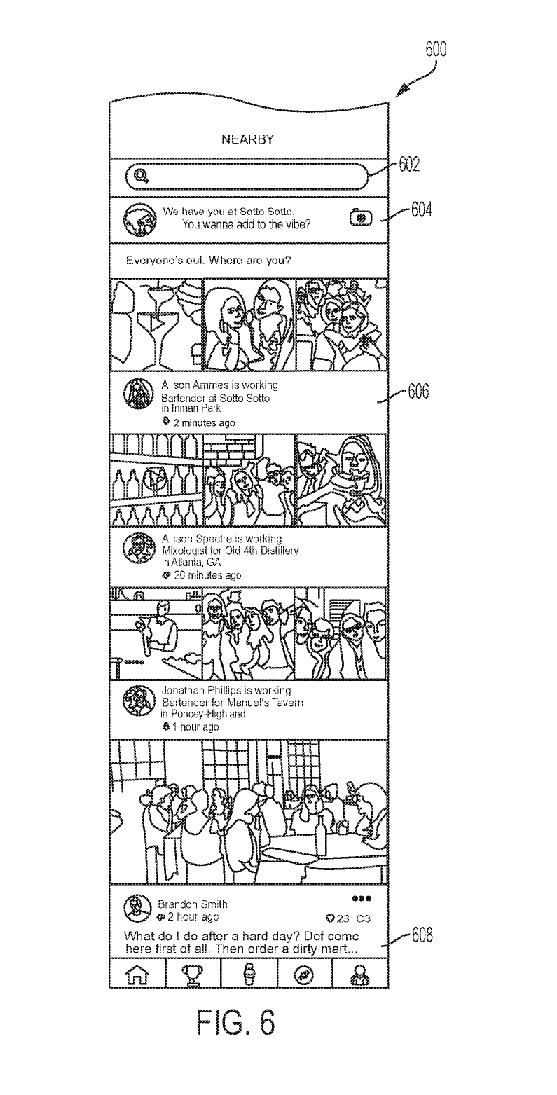

FIGS. 6-9 depict user interfaces that the system may display to a particular user using the dining establishment information tracking application, such as that described above. The user may access the dining establishment information tracking application from the user's mobile computing device. As may be understood from FIG. 6, the dining establishment information tracking application presents the user with a “Nearby” page 600. On the “Nearby” page 600, a user may enter one or more search terms into a search field 602 to determine dining establishments that are nearby the user. The “Nearby” page 600 also displays dining establishments that are nearby the user by using the user's location. The system may use the user's current location to determine that the user is at a particular location such as Sotto Sotto. The system may suggest to the user to add to the dining establishment information by selecting the “add to the vibe” button 604. The nearby page 600 may also include other information about where bartenders that the user follows currently are working 606. The nearby page 600 may further include information about where the user's friends are currently 608.

In response to the user selecting the profile of a particular bartender from the nearby page 600, the user may be directed to the detailed post page 700 where the user may view a detailed post about the location where the bartender is currently working. The detailed post page 700 may include the name of the dining establishment where the bartender is working 702, the address for the dining establishment 704, the particular bartender's hours 706, and people who are currently at the dining establishment where the bartender is working 704. The detailed post page 700 may also allow the user to add information about the particular dining establishment by selecting the second add to the vibe button 710.

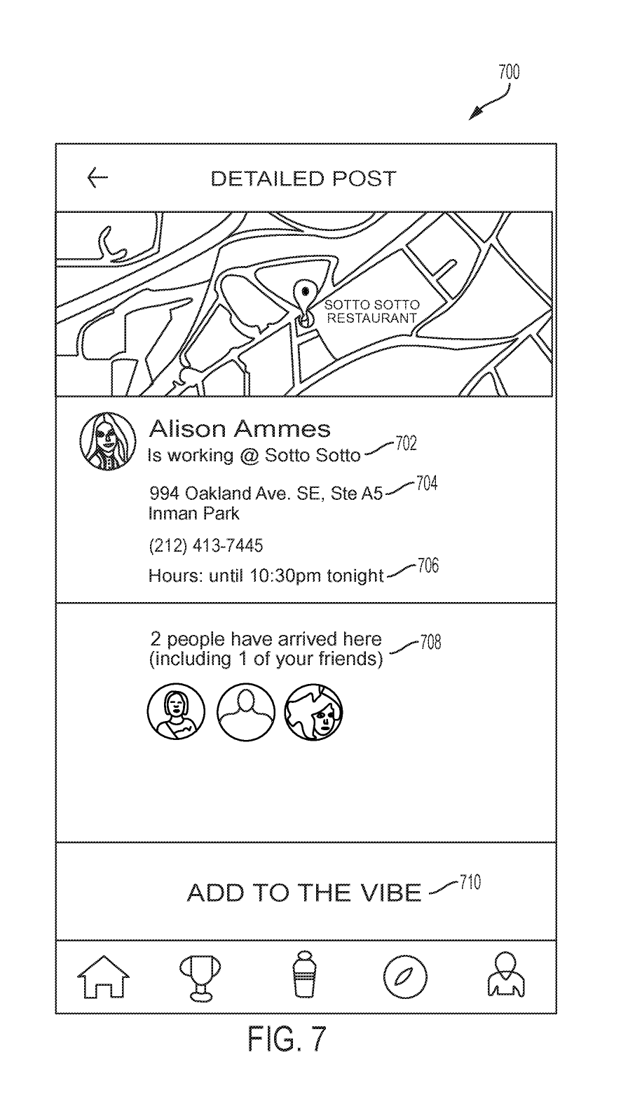

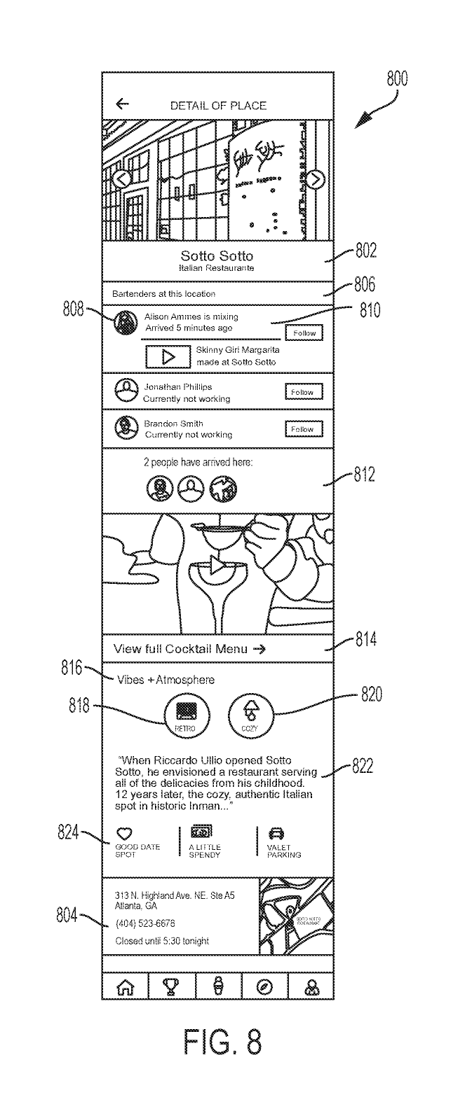

In response to the user selecting the name of the dining establishment where the bartender is working 702 as shown in FIG. 7, the user may be directed to the dining establishment information page 800 as shown in FIG. 8. The dining establishment information page 800 includes the name 802 and address 804 of the dining establishment 802 as well as other information such as bartenders who work at the particular dining establishment 806. The dining establishment information page 800 may include other information about the bartenders such as which ones are currently working 808, when they arrived 810, and who else is currently at the particular dining establishment 812. The dining establishment information page 800 may also include a cocktail menu button 814 that would allow the user to view the cocktail menu for the particular dining establishment. The dining establishment information page 800 further includes a description of the current vibe and/or atmosphere 816 of the particular dining establishment. The vibe/atmosphere description 816 may include words that describe the genre 818 of the particular dining establishment, words that describe the feeling 820 of the particular dining establishment, a description 822 of the particular dining establishment, and other features 824 about the particular dining establishment such as whether it's a good date spot, expensive, and/or whether they have valet parking. The vibe/atmosphere description 816 may also include photos and/or videos that were recently (e.g., within the last 30 minutes, hour, day, etc.) uploaded by other users. The vibe/atmosphere description 816 may further include photos and/or videos that were uploaded by other users in the past and that contain a timestamp of when they were uploaded (e.g., the user may upload the image when the user captures the image or the user may upload the image at a later time). For example, a user may go to two bars on the same night and take pictures at each bar at different times. The user may then go home and upload the pictures from the two different bars the next day. Because the pictures contain a time stamp, the system determines when and where the picture belongs for that particular location. In particular embodiments, the system may use software running on the user's portable device to determine the time and location that a particular image was captured. In some embodiments, the time and location may be embedded in the image file (e.g., as metadata), and/or the application may associate the time and location with the image when the image is uploaded to a central server and stored in a database. In various embodiments, a user may browse the vibe/atmosphere description 816 for what the particular dining establishment would be like on a typical Friday night by browsing the photos uploaded on past Friday nights.

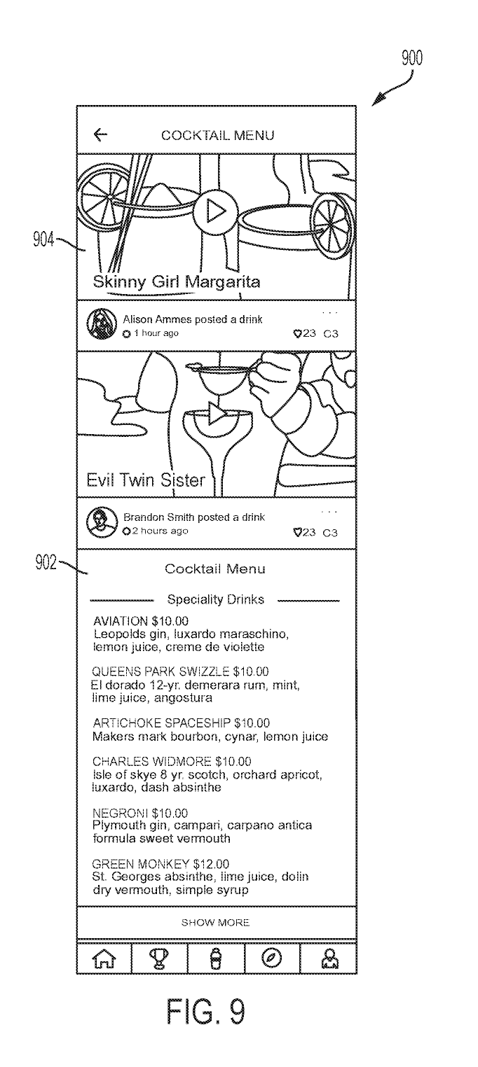

By selecting the cocktail menu button 814 of FIG. 8, the user may be directed to a cocktail menu page 900, as shown in FIG. 9. The cocktail menu page 900 may include information about the cocktails offered by the particular dining establishment 902. The cocktail menu page 900 may further include a video 904 showing, for example, a particular cocktail being made.

### CONCLUSION

Many modifications and other embodiments of the invention will come to mind to one skilled in the art to which this invention pertains, having the benefit of the teaching presented in the foregoing descriptions and the associated drawings. Therefore, it is to be understood that the invention is not to be limited to the specific embodiments disclosed and that modifications and other embodiments are intended to be included within the scope of the appended claims. Although the invention was discussed above in reference to dining establishments, the invention may be implemented in a variety of other different contexts. For example, the invention may be implemented in the context of any social establishment, especially those where services are provided in a social context (e.g., a gym, exercise class, movie theater, athletic field, shopping establishment, concert venue, etc.). In addition, although specific terms are employed herein, they are used in a generic and descriptive sense only and not for the purposes of limitation.

We claim:

1. A non-transitory computer-readable medium storing computer-executable instructions for:
receiving, from a first user, via a user interface of a first portable computing device associated with the first user, a first request to update a data structure to include first bar activity information for a first bar, the data structure being a data structure that an information tracking server will access to determine current bar activity information for one or more nearby bars to one or more users who initiate a search for one or more nearby bars using their respective portable computing device;
at least partially in response to receiving the first request:
receiving the first bar activity information for the first bar from the first user via the first portable computing device;
determining a current location of the first portable computing device associated with the first user;
using the determined current location of the first portable computing device associated with the first user to determine one or more bars that are proximate to the first user;
determining whether the one or more bars that are proximate to the first user include the first bar;
facilitating a display, to the first user via the user interface of the first portable computing device, of a listing of the one or more bars that are proximate to the first user and prompting the first user to select, via the user interface, the first bar from the listing of the one or more bars that are proximate to the first user;
at least partially in response to determining that the one or more bars that are proximate to the first user include the first bar and receiving a selection, by the first user, of the first bar from the listing of the one or more bars that are proximate to the first user:
updating the data structure to include the first bar activity information for the first bar; and
associating the first bar activity information for the first bar with the first bar in the data structure;
receiving, from a second user, via a user interface of a second portable computing device associated with the second user, a second request to initiate a search for one or more nearby bars;
at least partially in response to receiving the second request:
determining a current location of the second portable computing device associated with the second user;
using the determined current location of the first portable computing device associated with the second user to initiate the search for one or more nearby bars;
completing the search, by locating one or more bars that are within a particular distance of the determined current location of the second portable computing device associated with the second user;
facilitating a display, to the second user via the user interface of the second portable computing device, of a listing of one or more bars identified in the search;
retrieving, from the data structure, the current activity information for the one or more bars identified in the search; and
displaying, to the second user via the user interface of the second portable computing device, the current bar activity information for at least one of the one or more bars identified in the search.

2. The non-transitory computer-readable medium of claim 1, wherein:
the at least one of the one or more bars identified in the search comprises the first bar; and
the non-transitory computer-readable medium further stores computer-executable instructions for:
determining a first time period during which the first user provided the first bar activity information; and
updating the data structure to associate the first bar activity information for the first bar with the first time period.

3. The non-transitory computer-readable medium of claim 2, further storing computer-executable instructions for:
receiving, from the second user, a request to view past bar activity information for the first bar from a second time period;
determining whether the second time period includes the first time period;
in response to determining that the second time period includes the first time period, displaying, to the second user via the user interface of the second portable computing device, the past bar activity information for the first bar from the second time period that includes the first bar activity information; and
in response to determining that the second time period does not include the first time period, displaying, to the second user via the user interface of the second portable computing device, the past bar activity information for the first bar from the second time period that does not include the first bar activity information.

4. The non-transitory computer-readable medium of claim 1, wherein the current bar activity information comprises demographic information for one or more customers of the at least one of the one or more bars identified in the search.

5. The non-transitory computer-readable medium of claim 4, wherein the demographic information is selected from a group consisting of:
a. age;
b. sex;
c. race;
d. ethnicity; and
e. number of people in the population.

6. The non-transitory computer-readable medium of claim 4, wherein the demographic information comprises a general age group for the one or more customers of the particular bar.

7. The non-transitory computer-readable medium of claim 1, wherein the first bar activity information comprises one or more pieces of media.

8. The non-transitory computer-readable medium of claim 7, further storing computer-executable instructions for determining one or more pieces of EXIF data for the one or more pieces of media;
and confirming that the one pieces of media were captured at the first bar based at least in part on the one or more pieces of EXIF data.

9. The non-transitory computer-readable medium of claim 7, wherein the one or more pieces of media are selected from a group consisting of:
a. one or more photos; and
b. one or more videos.

10. The non-transitory computer-readable medium of claim 1, wherein the current bar activity comprises bar activity for a time period selected from a group consisting of:
a. within a pre-determined time period of receiving the second request to initiate the search for the one or more nearby bars;
b. substantially contemporaneous with receiving the second request to initiate the search for the one or more nearby bars; and
c. within a pre-determined time period after receiving the second request to initiate the search for the one or more nearby bars.

11. The non-transitory computer-readable medium of claim 10, wherein the current bar activity comprises bar activity for a pre-determined time period after receiving the second request to initiate the search for the one or more nearby bars.

12. The non-transitory computer-readable medium of claim 1, wherein the current bar activity comprises population data for the particular bar.

13. The non-transitory computer-readable medium of claim 12, wherein the population data is selected from a group consisting of:
a. number of people at the particular bar;
b. number of people of a particular sex at the particular bar;
c. number of people of a particular age at the particular bar;
d. number of people of a particular race at the particular bar; and
e. number of people of a particular sexual orientation at the particular bar.

14. A computer system for facilitating storage and retrieval of current establishment data an establishment information database, the computer system comprising at least one processor and memory, wherein the system further comprises:
(a) an establishment information database storing current establishment data for a plurality of establishments, the current establishment data comprising establishment information associated with each of the plurality of establishments received within a pre-determined time period of a current time;
(b) executable software operatively installed on a portable computing device associated with a first user, the executable software displaying a first user interface, on a display screen of the portable computing device, that is adapted to receive a first request from the first user to update the one or more databases to include first establishment information for a first establishment, wherein:
the system is adapted for, at least partially in response to receiving the first request:
determining a location of the portable computing device;
determining whether the determined location of the portable computing device is a location of the first establishment;
in response to determining that the determined location of the portable computing device is the location of the first establishment:
updating the one or more databases to include the first establishment information; and
associating the first establishment information with the first establishment in memory; and
in response to determining that the determined location of the portable computing device is not the location of the first establishment, not updating the one or more databases to include the first establishment information; and
(c) executable software operatively installed on a second portable computing device associated with a second user, the executable software displaying a second user interface, on a display screen of the second portable computing device, that is adapted to receive a second request from a second user to display the current establishment data for at least one of the plurality of establishments, wherein:
the system is adapted for, at least partially in response to receiving the second request, displaying the current establishment data for the at least one of the plurality of establishments to the second user.

15. The computer system of claim 14, wherein:
the at least one of the plurality of establishments is the first establishment; and
the system is further adapted for:
determining a time of the first request;
determining whether the time of the first request is within the pre-determined time period of the current time;
at least partially in response to determining that the time of the first request is within the predetermined time period of the current time and receiving the second request, displaying the current establishment data for the first establishment that includes the first establishment information.

16. The computer system of claim 15, wherein the system is further adapted for:
at least partially in response to determining that the time of the first request is not within the predetermined time period of the current time and receiving the second request, displaying the current establishment data for the first establishment that does not include the first establishment information.

17. The computer system of claim 14, wherein
the second request further comprises one or more search criteria; and
the system is further adapted for determining which of the plurality of establishments meet the one or more criteria.

18. The computer system of claim 14, wherein the current establishment data comprises data selected from a group consisting of:
a. a number of people at each of the plurality of establishments;
b. a number of people of a particular sex at each of the plurality of establishments;
c. a number of people of a particular age at each of the plurality of establishments;
d. a number of people of a particular race at each of the plurality of establishments; and
e. a number of people of a particular sexual orientation at each of the plurality of establishments.

19. The computer system of claim 14, wherein the first establishment information comprises one or more images taken by the first user at the first establishment.

20. A computer system for facilitating informing a user about a dining establishment, the system comprising:
at least one processor; and
memory, wherein the computer system is adapted for:
receiving dining establishment information from at least two people within the particular dining establishment about an overall subjective appearance rating of one or more people at the dining establishment;
receiving dining establishment information from at least two people within the particular dining establishment about a percentage of a particular sex of the one or more people at the dining establishment;
receiving dining establishment information from at least two people within the particular dining establishment about a percentage of a particular age of the one or more people at the dining establishment; and
displaying to a user in real-time the overall subjective appearance rating, the percentage of the particular sex, and the percentage of the particular age of the one or more people at the dining establishment.
